(19) United States
(12) Patent Application Publication
(10) Pub. No.: US 2008/0213722 A1
(43) Pub. Date: Sep. 4, 2008

(54) Handpiece With Coating For Moved or Movable Parts

(76) Inventor: Rainer Hofer, Baienfurt (DE)

Correspondence Address: MARSHALL, GERSTEIN & BORUN LLP, 233 S. WACKER DRIVE, SUITE 6300, SEARS TOWER, CHICAGO, IL, 60606, US

(21) Appl. No.: 11/916,141

(22) PCT Filed: May 17, 2006
(86) PCT No.: PCT/EP2006/004686

§ 371 Date: Feb. 26, 2008

(30) Foreign Application Priority Data
May 30, 2005 (EP) 05011617.7

(51) Int. Cl. A61C 1/00

(52) U.S. Cl. 433/131

(57) ABSTRACT

A handpiece, in particular for medical, dental-medical or dental-technical purposes, has a drive mechanism for a tool to be held by the handpiece, wherein moving or movable parts of the handpiece are provided at least partly with a coating, which is chromium nitride and/or titanium nitride+gold.

The present invention concerns a handpiece in accordance with the preamble of the claim 1, which has a drive mechanism for a tool to be held by the handpiece, wherein moving or movable parts of the handpiece are at least partly provided with a coating. The present invention particularly concerns a handpiece which is provided for medical, dental-medical or dental-technical purposes.

Dental-medical or dental-technical handpieces exist in the most varied configurations. The handpieces may thereby be differentiated both according to their form or arrangement of the tools to be operated and also with regard to the drive mechanism put to use. Thus there is on the one hand the possibility of arranging the tool at an angle of about 90° to the longitudinal axis of the handpiece, whereby such configurations are used for example with dental drills for working involving removal of tooth substance. In dental technology, in contrast, for the production of tooth prosthetics, handpieces are frequently put to use in which the tool is arranged in the direction of the longitudinal axis of the handpiece.

If the tool is to be set into rotation with the aid of the drive mechanism, in dental medicine or dental technology in substance two different drive principles are put to use. On the one hand, air turbines are frequently put to use in which a rotor arranged in the head section of the handpiece is set into rotation by means of compressed air; on the other hand also electric drives are put to use which in particular bring about advantages if an exact control of the speed of rotation and the torque exercised by the tool is desired. Further, however, there exist also pneumatic drives which are put to use for example when the tool is not to be set into rotation but is to be set into an oscillating movement.

It is common to all different configurations of dental-medical or dental-technical handpieces that the moving or movable parts located therein are exposed to a relatively great loading. Here it also has to be taken into account that predominantly miniaturized components are involved, since the cramped space conditions within the handpieces do not allow use of large-volume components. However, the smaller are the components put to use, the more difficult it is for these to bear the loads appearing during operation or use of the handpiece. Components which are exposed to a particularly great load are for example all components of the drive mechanism which are responsible for the transmission of a rotation to the tool or which are in general responsible for a movement of the tool.

A further region of a dental handpiece which is exposed to a relatively great load, and with that to the danger of wear and tear, is the head section within which the tool is arranged. Handpieces are normally so configured that a simple change of the tools is made possible. This is already required because the tools also wear in the course of the time, and for hygienic reasons must be cleaned and sterilized. Correspondingly there come to use so-called mounting devices which during operation hold the tool securely and firmly and then make possible a removal of the tool. Also the components of such a mounting device are exposed to a great load, since for the firm and secure holding of the tool within the mounting device a high transmission of force is required.

To reduce the wear and tear of the various components of a mounting device it is proposed in WO 03/071973 A1 to provide the components of a mounting device of a dental handpiece with a coating which has graphite or chromium nitrate. In the case of the coating containing graphite, attention is particularly directed to so-called diamond-containing or diamond-like mechanically resistant coatings (diamond like carbon—DLC) which manifest a great hardness and in addition also improve the frictional characteristics due to the amorphous carbon. A further characteristic of the coatings described in WO 03/071973 A1 consists in that these counteract a corrosion of the components of the mounting device.

The coating of certain components of a dental handpiece is also described in WO 2004/056280 A1. Here, however, attention is primarily directed to the coating leading to a reduction of friction and correspondingly that an excessive lubrication of the various handpiece components can be done without. Correspondingly it is proposed in WO 2004/056280 A1 to provide parts of a dental handpiece moved with respect to one another with a coating which has a lubricant. As a particularly preferred embodiment in turn mention is made of the use of diamond-like carbon layers DLC.

Starting from the above-described state of the art the present invention is based on the object of indicating a handpiece in particular for medical, dental-medical or dental-technical purposes, configured in a new manner, which with regard to its moving or movable parts manifest further improved characteristics.

The object is achieved by a handpiece which has the features of claim 1. Advantageous developments of the invention are subject of the dependent claims.

It is the core idea of the present invention to provide moving or movable parts of the handpiece with a coating having chromium nitride (CrN) and/or titanium nitride+gold (TiN+Au) to additionally improve the operating characteristics thereof. Unlike the state of the art which suggests the use of diamond-like coatings or chromium nitrate layers, in accordance with the present invention a new coating kind is thus put to use, since tests have shown that chromium nitride or the combination titanium nitride+gold brings about further improved characteristics in comparison with the coatings mentioned above, in particular with regard to use in the dental-medical or dental-technical field. Further advantages arise in that coating the components with chromium nitride or titanium nitride+gold can be carried out with a very high precision and in particular reliably and reproducibly.

In accordance with the present invention thus there is proposed a handpiece with a drive mechanism for a tool to be held by the handpiece, in particular for medical, dental-medical or dental-technical purposes, wherein moving or movable parts of the handpiece are provided at least partly with a coating and wherein according to the invention it is provided that the coating has chromium nitride and/or titanium nitride+gold.

In a first particularly preferred embodiment of the present invention the handpiece has a mounting device for the selective mounting of a tool to be moved, in particular to be set into rotation, by the drive mechanism, wherein elements of this mounting device are provided with the chromium nitride coating or titanium nitride+gold coating put to use according to the invention. A second preferred embodiment of the present invention consists in using a drive mechanism for the tool which has at least one shaft driven and mounted rotatably, wherein bearing elements for the shaft and/or coupling parts for the transmission of rotation are provided with the coating according to the invention.

Thereby there are involved two particularly preferred regions or components of the handpiece for which the chromium nitride coating or titanium nitride+gold coating according to the invention is to be put to use. Of course, however, all components of the handpiece which are subject to wear can be provided with the coating. The chromium nitride or titanium nitride+gold coating can thus be put to use in a very versatile manner and contributes in all areas to improve the operating characteristics of the coated components and with that of the handpiece overall.

Also, the present invention is under no circumstances restricted to the use of especially configured handpieces. The chromium nitride or titanium nitride+gold coating can rather be put to use for all handpieces which are used in medical, dental-medical or dental-technical fields. In this way the operating characteristics of both dental drilling handpieces and also straight motor handpieces for the laboratory field can be further optimized.

Below, the invention will be explained in more detail with reference to the accompanying drawings. There is shown:

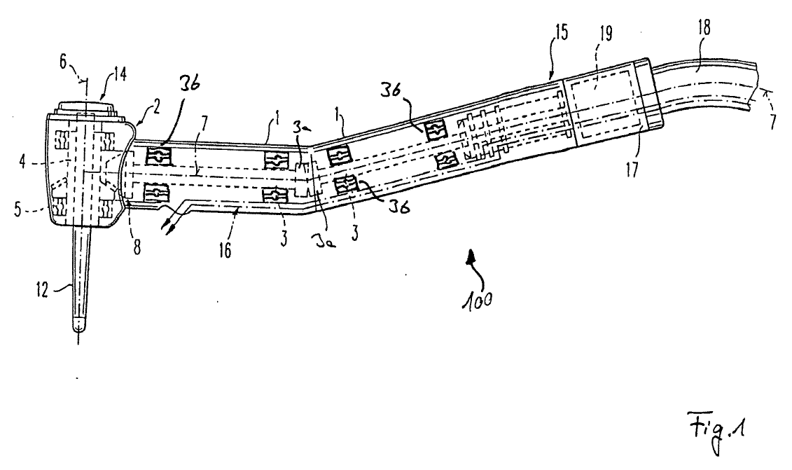

FIG. 1 a first embodiment of a dental handpiece according to the invention, in side view;

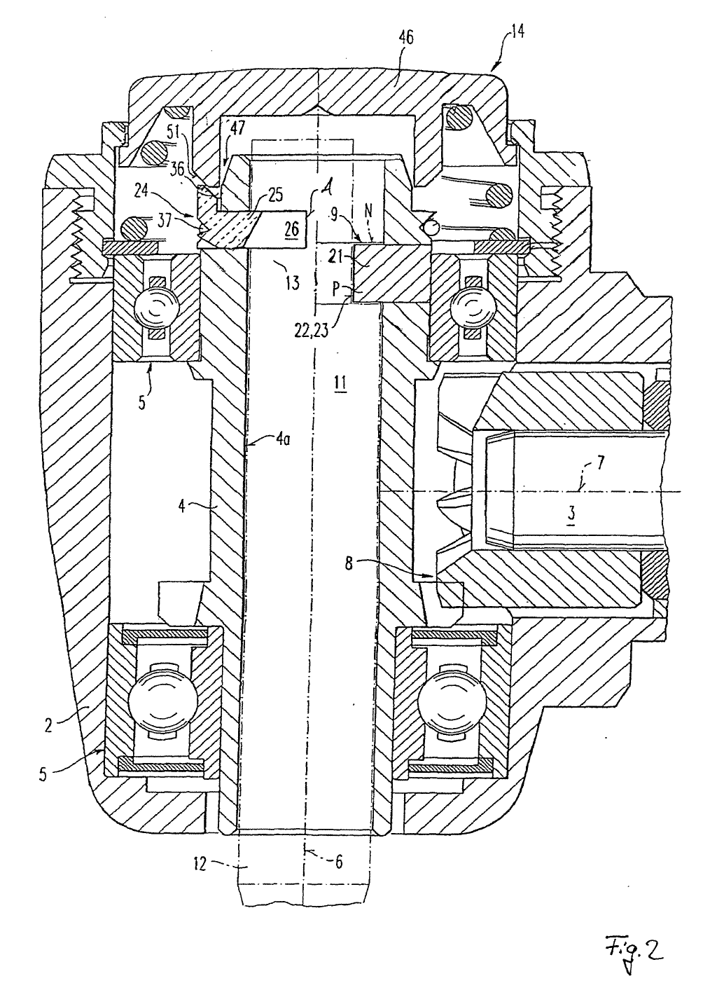

FIG. 2 the head section of the handpiece of FIG. 1, in vertical section; and

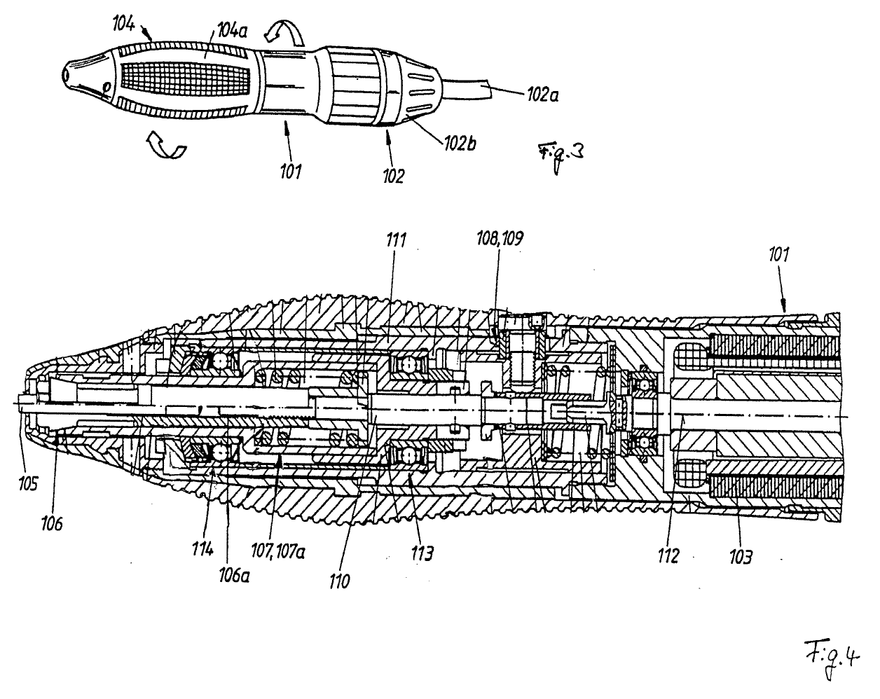

FIGS. 3 and 4 a further embodiment of a straight motor handpiece, which is configured in accordance with the present invention.

Below, two different handpieces are explained, which are provided for use in the dental-medical and dental-technical fields and are configured according to the teaching of the present invention. On the one hand, there is involved a drilling handpiece and on the other hand a straight motor handpiece. However, it is to be pointed out again at this point that use of the chromium nitride or titanium nitride+gold coating provided in accordance with the present invention can find employment with all medical, dental-medical or dental-technical handpieces.

In the case of the embodiment illustrated in FIGS. 1 and 2 there is involved a handpiece which is known from DE 196 29 902 A1 of the applicant. Since the configuration of this handpiece is already adequately described in that publication, the construction thereof will be explained merely briefly in the following.

The main parts of the handpiece 100 illustrated in FIGS. 1 and 2 are a grip sleeve 1 with a head housing 2 at its forward end, a drive shaft section comprehending two drive shafts 3, which is rotatably mounted in the grip sleeve 1 by means of appropriate bearings 3b, a drive sleeve 4 which is mounted in the head housing 2 rotatably around an axis of rotation 6 by means of rotary bearings 5, wherein the axis of rotation 6 extends preferably at right-angles to the longitudinal middle axis 7 of the grip sleeve 1, a drive connection between the drive shaft section and the drive sleeve 4, here in form of an angular transmission 8 with corresponding pinions, a first coupling 9 for the releasable rotational entrainment connection of a shaft 11 of a rotary tool 12 insertable from the outside into the drive sleeve 4, a second coupling 13 for the releasable axial connection of a shaft 11 with the drive sleeve 4, and an actuation device 14 for the release of the second coupling 13 for the purpose of removal of the tool 12 from the handpiece 100.

The grip sleeve 1 is connectable by means of a plug-in connection 15 with a connection piece 17 of a flexible supply line 18, the other end of which is connected with a non-illustrated supply device for the supply of the handpiece with required media, such as for example electrical drive energy, blasting air, water and/or spray. There serve for this so-called media lines 16 which may extend longitudinally through the supply line 18 and the plug-in connection 15, as is known in itself. The media lines for water and/or air, and light, end in—or in the vicinity of—the head housing 2, wherein their exit openings are directed at the treatment site located at the tip of the tool 12.

An electrical drive motor 19 is arranged, in a manner known in itself, in the connection piece 17. With the aid of the motor 19 the tool 12 is set into a rotation, whereby the transmission of the motor movement to the tool 12 is effected via the two shafts 3, coupling elements 3a located on the shafts 3, and the angular transmission 8.

The first coupling 9 in the head housing 2 is formed by an inner projection 21 in the drive sleeve 4 having a coupling surface 22, which bears on a coupling surface 23 of the shaft 11 with slight play for movement, wherein the coupling surface 22 is formed by a recess or flattening of the shaft 11 running out to the end side. The inner projection 21 is formed by a circular section shape coupling part, which is emplaced as a matching piece in a groove N.

The second coupling 13, for the axially effective connection of the shaft 11 with the drive sleeve 4, is formed by a coupling slider 24 which is mounted radially movably in a radial guide slot of the drive sleeve 4 with slight play for movement, and has at its radially inner end a coupling nose 25, and a coupling recess 26 in the shaft 11 receiving the latter.

The coupling slider 24 is displaceable between a coupling position illustrated in FIG. 2, in which its inwards movement is limited by a stop A, and in which the coupling nose 25 projects into the hollow cylindrical insertion hole 4a of the drive sleeve 4, and a decoupling position or release position which is in comparison displaced outwardly, in which the coupling nose 25 does not project into the insertion hole 4a. For the automatic return of the coupling slider 24 into its coupling position there is provided a spring 37 urging it radially inwardly. The spring 37 is, upon displacement of the coupling slider 24 into its release position, opened elastically, which is made possible by its clip-like form or C-form. Through the spring elastic contraction, the coupling piece 24 is automatically displaced into its coupling position.

For release of the second coupling 13 there is provided the actuation device 14, which is arranged on the side of the head housing 2 away from the tool 12, or is accessible from this side. It has a pressure member 46 which is axially manually displaceable in a guide 47 between a functional position displaced inwardly and a standby position displaced outwardly.

For opening the coupling 13, the pressure member 46 is pushed in by pressure of the finger of the associated operation hand, whereby conical surfaces 36, 51 meet one another and the coupling slider 24 is forced radially outwardly into its release position and the shaft 11 can be drawn out of the insertion hole 4a. The coupling of the shaft 11 is effected automatically upon insertion into the insertion hole 4a by means of a displacement of the coupling slider 24 against the spring force and automatic latching into the recess 26 in the shaft 11, which may be segment-form, e.g. be formed as secantial groove or ring-like.

The handpiece 100 illustrated in FIGS. 1 and 2 has thus a number of different components which are moved or move (with respect to one another) during operation, to set the tool 12 into the desired rotation with the aid of the motor 19. Further, there are provided components which are moved out of the head section 2 during the mounting or removal of the tool 12, to make possible a secure gripping of the tool and a release of this grip.

In accordance with the present invention it is now provided that moving or movable parts of this handpiece 100 are provided with a chromium nitride coating (CrN) and/or a titanium nitride+Gold coating. There are involved in particular those parts which are exposed to a greater load during operation, since with the aid of the chromium nitride or titanium nitride+gold coating the surface characteristics of these components can be improved significantly.

Thus the chromium nitride coating put to use according to the invention distinguishes itself by the following characteristics:
a) high hardness and adhesive strength,
b) very good chemical resistance,
c) high temperature resistance in air,
d) a very small coefficient of friction compared to steel,
e) good sliding behaviour with inadequate lubrication and strong mechanical load.

A further positive characteristic of the chromium nitride coating consists in that also the application of relatively thick layers is possible without problem. The application is preferably carried out by means of PVD (Physical Vapor Deposition) technology in which layer thicknesses of 5 μm can be attained without further ado. In turn this means that also an additional wear reserve for the coated components is provided through the chromium nitride coating, since a coating of the components concerned still remains ensured even over a longer use time period. In connection with the high hardness and a low brittleness, there is obtained for the coated parts an extremely high abrasion resistance. Since, beyond this, the chromium nitride coating also increases the corrosion resistance of the corresponding components, their operating characteristics can thus be improved considerably.

The alternatively or supplementarily used titanium nitride+gold coating consists initially of a titanium nitride layer (TiN) which is covered by a gold layer (Au). The titanium nitride layer thereby has a thickness of up to 1 μm, whilst however the gold layer is up to 0.5 μm thick. The application of the coating is carried out with PVD magnetron sputter technology which makes possible a reliable and uniform application of the coating on the parts of components concerned.

Particular advantages of the titanium nitride+gold coating are:
a) a low overall layer thickness of max. 1.5 μm,
b) a significant increase of wear resistance,
c) a high microsurface hardness,
d) a better emergency running characteristic with inadequate lubrication, due to the increased gold amount,
e) a significant reduction of the friction and adhesion to the counter-body, and
f) an increased standing time prolongation due to the improved abrasion resistance.

In the case of the handpiece 100 illustrated in FIGS. 1 and 2 it is correspondingly provided to coat at least those components which are exposed, during operation, to a greater load due to surface contact with other components. Here, there are involved in particular the shafts 3 of the drive mechanism or the coupling parts 3a thereof, and the components of the angular transmission 8. Furthermore the bearing parts, that is the bearing rings of the bearings 3b used for mounting the shafts 3 and of the bearing 5 for the drive sleeve, can be coated. A further field of application for the coating according to the invention is represented by the various components of the mechanism for mounting or coupling the tool 12; that is, the various components of the couplings 9 and 11. All these components are exposed, during the operation of the handpiece 100, to a relatively strong load, since they stand in surface contact with other elements and transmit forces. Through coating of these components with chromium nitride and/or titanium nitride+gold, which is relatively simple to carry out, now the characteristics thereof are increased with regard to wear and tear manifestations, so that a reliable and fault-free operation of the handpiece 100 is ensured over a longer use time period.

As a second application example a straight motor handpiece is presented, which is already known from DE 44 06 855 A1 of the applicant. This handpiece is illustrated in FIGS. 3 and 4.

The rod-shaped, straight handpiece 101 consists of a rearward motor part 102 having a drive motor built therein, in particularly electric drive motor 103, and a forward handpiece part 104 into which a working tool can be mounted from the front with its shaft 105. For this purpose there serves a sleeve-like, slit collet 106, which is coaxially arranged in the handpiece part 104, and which is part of a drive shaft 107, which is coaxially rotatably mounted in the handpiece part 104 and is connected with the drive motor 103 for the rotation thereof. The collet 106 allows itself to be opened and closed by a relative rotation between the motor part 102 and a grip sleeve 104a of the handpiece part 104. For this purpose there is integrated into the handpiece part 104 an actuation mechanism 108, which is effective between the grip sleeve 104a and the drive shaft 107 and has a transmission 109 which converts the rotation of the grip sleeve 104a into an axial movement of a round draw bar 110, which extends from the rear coaxially through a bearing sleeve 107a of the drive shaft 107, is mounted therein axially movably in a bore and with its forward end is screwed into an inner threading 106a of the collet 106. The grip sleeve 104a is mounted on a sleeve-like internal housing 111, rotatably and longitudinally displaceably around the longitudinal middle axis 112 of the handpiece 101. In the internal housing 111 the drive shaft 107 is rotatably mounted by means of two roller bearings 113, 114 having an axial spacing from one another. The motor part 102 is connectable to an energy supply source and/or a control device by means of a cable 102a and possibly a connecting part 102b.

As in the case of the embodiment in accordance with FIGS. 1 and 2 it is provided that also with this straight motor handpiece 101 the moving or movable components, which stand in surface contact and transfer force, are provided with a chromium nitride or titanium nitride+gold coating. In this case therefore primarily the components of the various bearings 113, 114 and the collet 106 for the mounting of the tool shaft 105 are coated. In turn there are provided the parts already described above.

Finally it is again to be indicated that the coating with chromium nitride and/or titanium nitride+gold can be put to use with differently configured handpieces and drive principles. It would particularly also be conceivable in the case of the handpiece illustrated in FIGS. 1 and 2 to employ an air turbine in the head section. Also in this case the coating of the bearing parts for the turbine as well as the elements for mounting or holding the tool with chromium nitride and/or titanium nitride+gold would be conceivable, since in this case the advantages striven for according to the invention with regard to resistance with respect to excessive wear and tear of the different components would also arise.

Overall it is to be understood that through the proposal according to the invention to coat components of a handpiece with chromium nitride and/or titanium nitride+gold the characteristics of these components and with that of the handpiece overall can be improved considerably. Thereby, a particular advantage of the present invention consists in that coating with chromium nitride or titanium nitride+gold can be carried out relatively simply and in high quality, so that the invention or the improvements therewith striven for can thus can be realised in a simple but reliable way.

1. Handpiece comprising a drive mechanism for a tool to be held by the handpiece, said handpiece further comprising moving or movable parts provided at least partly with a coating
comprising at least one of (a) chromium nitride and (b) titanium nitride and gold.

2. Handpiece according to claim 1,
wherein
the handpiece comprises a device for the selective mounting or coupling of a tool to be moved by the drive mechanism, wherein elements of this device are provided with said coating.

3. Handpiece according to claim 2,
wherein
the device for the mounting of the tool has a collet.

4. Handpiece according to claim 1, wherein
the tool is rotatable by the drive mechanism.

5. Handpiece according to claim 4,
wherein
the drive mechanism for the tool comprises at least one driven and rotatably mounted shaft said handpiece further comprising at least one of bearing elements for the shaft and coupling parts for the transmission of rotation provided with said coating.

6. Handpiece according to claim 1, wherein
the coating comprises chromium nitride and has a thickness of up to 5 μm.

7. Handpiece according to claim 1, wherein
the coating comprises titanium nitride+gold and has a thickness of 1.5 μm or less.

8. Handpiece according to
claim 1, comprising a dental drilling handpiece.

9. Handpiece according to claim 1, comprising a straight motor handpiece.
